(19) United States
(12) Patent Application Publication
(10) Pub. No.: US 2020/0318949 A1
(43) Pub. Date: Oct. 8, 2020

(54) DISPLACEMENT SENSOR FOR FREQUENCY MODULATION CONTINUOUS WAVE LASER INTERFERENCE OPTICAL FIBER AND DISPLACEMENT DETECTION METHOD THEREFOR

(71) Applicants: Gang ZHENG, Xi'an (CN); XI'AN TECHNOLOGICAL UNIVERSITY, Xi'an (CN)

(72) Inventors: Gang ZHENG, Xi'an (CN); Weiguo LIU, Xi'an (CN); Ming GAO, Xi'an (CN); Haibin CHEN, Xi'an (CN); Xiongxing ZHANG, Xi'an (CN); Wei WANG, Xi'an (CN)

(21) Appl. No.: 16/957,390

(22) PCT Filed: Dec. 20, 2018
(86) PCT No.: PCT/CN2018/122245

§ 371 Date: Jun. 24, 2020

(30) Foreign Application Priority Data
Dec. 25, 2017 (CN) 201711418334.0

(51) Int. Cl. G01B 11/14; G01B 11/10; G01B 9/02

(52) U.S. Cl. CPC G01B 11/14; G01B 9/02023; G01B 11/105

(57) ABSTRACT

A displacement sensor for a frequency modulation continuous wave laser interference optical fiber, comprising a single mode frequency modulation continuous wave laser (1) and at least one optical fiber displacement sensing system; the optical fiber displacement sensing system comprises an optical circulator (2), an optical fiber collimator (3), a partial reflector (4), a cooperative reflector (5) and a photoelectric detector (6); the single mode frequency modulation continuous wave laser (1) is connected to an incident port of the optical circulator (2) by means of a single mode optical fiber or an optical fiber coupler; an adjacent emergent port of the optical circulator (2) is connected to the optical fiber collimator (3) by means of the single mode optical fiber; a third port of the optical circulator (2) is connected to the photoelectric detector (6).

### FIELD OF THE INVENTION

The present disclosure relates to the technical field of displacement sensing, in particular to a frequency modulation continuous wave laser interference optical fiber displacement sensor.

### BACKGROUND OF THE INVENTION

Displacement sensing is a very important measurement and test technology in the fields of scientific research, industry and military. The optical displacement sensing technology is particularly valued due to its high precision, non-contact and immunity to electromagnetic interference. In addition, the optical fiber displacement sensing technology even has the advantages of small size, light weight, compact structure and flexible form. At present, a wide variety of optical fiber displacement sensing technologies have been reported, mainly including an intensity modulation type optical fiber displacement sensor, and a laser interference type optical fiber displacement sensor. The intensity modulation type optical fiber displacement sensor is simpler in detection method and signal processing, but has the defects of low precision, poor stability, nonlinear response and small measurement range. The laser interference type optical fiber displacement sensor using a conventional optical zero-beat interference technology can achieve very high measurement accuracy, but its measurement precision depends on the stability of laser wavelength, and because an interference signal is a static signal and has the problem of fringe counting, it is difficult to obtain high-precision displacement sensing measurement within a large dynamic range.

### SUMMARY OF THE INVENTION

The present application provides a frequency modulation continuous wave laser interference optical fiber displacement sensor and a displacement detection method thereof, which solve the problems in the prior art.

The technical scheme of the present disclosure is as follows:

A frequency modulation continuous wave laser interference optical fiber displacement sensor includes a single-mode frequency modulation continuous wave laser and at least one optical fiber displacement sensing system connected with the single-mode frequency modulation continuous wave laser. The optical fiber displacement sensing system includes an optical circulator, an optical fiber collimator, a partial reflecting mirror, a cooperative reflecting mirror and a photoelectric detector. The single-mode frequency modulation continuous wave laser is connected with an incident port of the optical circulator by means of a single-mode optical fiber or an optical fiber coupler. An adjacent emergent port of the optical circulator is connected with the optical fiber collimator by means of the single-mode optical fiber. A third port of the optical circulator is connected with the photoelectric detector. The partial reflecting mirror is arranged behind the optical fiber collimator. The cooperative reflecting mirror is arranged behind the partial reflecting mirror. The cooperative reflecting mirror is attached to the surface of a target object to be detected and moves together with the target object to be detected.

Further, the single-mode frequency modulation continuous wave laser is fused to the incident port of the optical circulator by means of the single-mode optical fiber and the optical fiber coupler, or connected to the incident port of the optical circulator through a flange.

Further, the partial reflecting mirror is attached to an emergent end surface of the optical fiber collimator by means of adhesive bonding or mechanical fixing.

Further, an emergent mirror surface of the optical fiber collimator is coated with a partially reflecting and partially transmitting optical film material to form the partial reflecting mirror.

Further, the optical fiber collimator is selected from a Grin-lens (G-lens) optical fiber collimator, a spherical lens (C-lens) optical fiber collimator and an aspherical optical fiber collimator.

Further, the cooperative reflecting mirror is selected from the partial reflecting mirror and a total reflecting mirror.

Further, a dielectric reflecting mirror or a metal reflecting mirror is selected when the cooperative reflecting mirror is the total reflecting mirror.

According to the optical fiber displacement sensor, the displacement detection method thereof is as follows: coupling frequency modulation continuous waves emitted by the single-mode frequency modulation continuous wave laser to the incident port of the optical circulator by the single-mode optical fiber or the optical fiber coupler; outputting the frequency modulation continuous waves by the adjacent emergent port of the optical circulator; then coupling and outputting the frequency modulation continuous waves by the optical fiber collimator; reflecting one part of emergent light by the partial reflecting mirror; transmitting the other part of the emergent light by the partial reflecting mirror and irradiating the other part of the emergent light onto a mirror surface of the cooperative reflecting mirror moving along with the target object to be detected; reflecting the light by the cooperative reflecting mirror to allow the light to be returned to the partial reflecting mirror and superposed and interfered with reflected light of the partial reflecting mirror to form a beat frequency signal; coupling the beat frequency signal back to the single-mode optical fiber by the optical fiber collimator and transmitting the beat frequency signal into the optical circulator; transmitting the beat frequency signal out of the third port of the optical circulator; coupling the beat frequency signal to the photoelectric detector through the single-mode optical fiber, and converting the beat frequency signal into an electric signal, such that displacement information of the target object can be obtained by processing and analyzing the electric signal.

The present disclosure has the following beneficial effects that:

1. the present disclosure greatly reduces the loss of test laser in a light path, improves the utilization efficiency of laser energy, eliminates the influence of feedback light on a light source, remarkably improves the signal-to-noise ratio of a frequency modulation continuous wave laser interference signal, can obtain the measurement precision of less than 10 nm within a wide range of more than several centimeters, and realizes precise optical fiber displacement sensing measurement within a large dynamic range; and

2. the present disclosure forms an all-optical fiber type frequency modulation continuous wave laser interference optical fiber displacement sensing light path, which is compact in structure and stable in performance.

### BRIEF DESCRIPTION OF THE DRAWINGS

FIG. 1 is a schematic diagram of an embodiment 1 of the present disclosure.

FIG. 2 is a graph showing the relationship between the initial phase offset of a beat frequency signal and a displacement of an object to be detected during a displacement sensing measuring process.

FIG. 3 is a schematic diagram of an embodiment 2 of the present disclosure.

In the figures, 1—single-mode frequency modulation continuous wave laser, 2—optical circulator, 3—fiber collimator, 4—partial reflecting mirror, 5—cooperative reflecting mirror, 6—photoelectric detector, and 7—optical fiber coupler.

### DETAILED DESCRIPTION OF THE EMBODIMENTS

In order to make the purposes, technical schemes and advantages of the present disclosure more apparent, the present disclosure will be further described in detail below in combination with the drawings. Obviously, the described embodiments are only part of the embodiments of the present disclosure, but not all of them. On the basis of the embodiments of the present disclosure, all other embodiments obtained by those of ordinary skill without creative work fall within the scope of protection of the present disclosure.

The frequency modulation continuous wave laser interference optical fiber displacement sensor of the present disclosure includes a single-mode frequency modulation continuous wave laser 1 and at least one optical fiber displacement sensing system connected with the single-mode frequency modulation continuous wave laser. The optical fiber displacement sensing system includes an optical circulator 2, an optical fiber collimator 3, a partial reflecting mirror 4, a cooperative reflecting mirror 5 and a photoelectric detector 6. The single-mode frequency modulation continuous wave laser 1 is coupled to an incident port of the optical circulator 2 by means of a single-mode fiber or an optical fiber coupler 7. An adjacent emergent port of the optical circulator 2 is connected to the optical fiber collimator 3 by means of the single-mode optical fiber. A third port of the optical circulator 2 is connected with the photoelectric detector 6. The partial reflecting mirror 4 is arranged behind the fiber collimator 3. The cooperative reflecting mirror 5 is arranged behind the partial reflecting mirror 4. The cooperative reflecting mirror 5 moves together with a target object to be detected.

The basic principle of the frequency modulation continuous wave laser interference optical fiber displacement sensor of the present disclosure is that: a dynamic beat frequency signal may be naturally generated by using a frequency modulation continuous wave laser interference technology, and the measurement of the relative displacement of an object may be realized by using a linear relationship between an initial phase of the dynamic signal and the relative displacement of the object. The optical fiber displacement sensor has the advantages of high measurement precision, capability of distinguishing displacement directions, large measurement dynamic range and the like, so that the measurement precision and the dynamic range of the optical fiber displacement sensor based on frequency modulation continuous wave laser interference are higher than those of a traditional laser interference type optical fiber displacement sensor.

Several embodiments of the present disclosure are described below:

### Embodiment 1

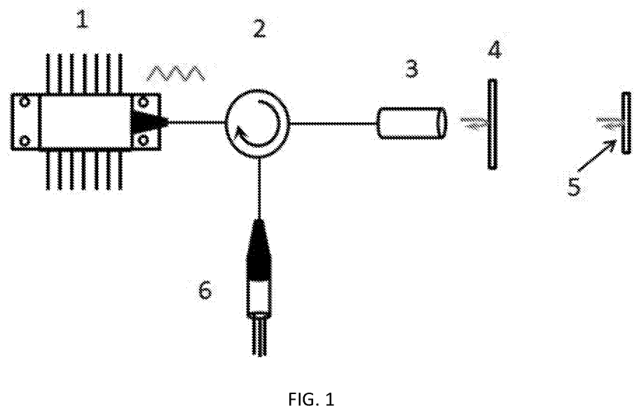

As shown in FIG. 1, embodiment 1 provides a single-path form frequency modulation continuous wave laser interference optical fiber displacement sensor, that is, a single-mode frequency modulation continuous wave laser is connected with only one optical fiber displacement sensing system. Specifically, the single-mode frequency modulation continuous wave laser 1 is connected with one port of the optical circulator 2 by means of a single-mode optical fiber, in the present embodiment, they are connected in a fusing mode, but in other embodiments, they may be connected using a flange.

An adjacent emergent port of the optical circulator 2 is connected to the pigtail of an optical fiber collimator 3 by means of the single-mode optical fiber. A third port of the optical circulator 2 is connected to the pigtail of the photoelectric detector 6 by means of the single-mode optical fiber.

A partial reflecting mirror 4 is arranged at the rear end of the optical fiber collimator. In the present embodiment, the partial reflecting mirror 4 is arranged as an independent device behind the optical fiber collimator 3. But in other embodiments, the partially reflecting mirror 4 may be attached to the outside of an emergent end surface of the optical fiber collimator 3 by means of adhesive bonding or mechanical fixing, or the function of the partial reflecting mirror 4 is realized by coating an emergent end surface of the optical fiber collimator 3 with a partially reflecting and partially transmitting optical film material.

In a current modulation mode, frequency linearly modulated frequency modulation continuous wave laser is emitted using the single-mode frequency modulation continuous wave laser 1. The laser is coupled to an input port of the optical circulator through an optical fiber and is outputted from the adjacent emergent port of the optical circulator 2. The output light is transmitted into the optical fiber collimator 3 through the single-mode optical fiber and passes through the partial reflecting mirror 4 from the optical fiber collimator 3. Part of the light is reflected to serve as reference light, and part of the light is transmitted and then irradiated onto the cooperative reflecting mirror 5 attached to the surface of a moving object to be detected after being transmitted and is reflected to serve as signal light. The signal light is returned in the original way, and superposed and interfered with the reference light on a reflecting surface of the partial reflecting mirror 4 to form a beat frequency signal. The beat frequency signal is coupled back to an optical fiber loop by the optical fiber collimator 3, transmitted into the original emergent port of the optical circulator 2 and transmitted out of the third port of the optical circulator 2, is received by the photoelectric detector 6 and is converted into an electrical signal.

Assuming that the average light intensity of the reference light is l₁ and the average light intensity of the signal light is l₂, the beat frequency signal light intensity is

$$\begin{matrix}I ( t ) = {I}_{0} [ 1 + V cos ( \frac{2 π Δ {vv}_{m} OPD}{c} t + \frac{2 π}{{λ}_{0}} OPD ) ] \\ = {I}_{0} [ 1 + V cos ( 2 π {v}_{b} t + {φ}_{b 0} ) ]\end{matrix}$$

where, l₀ [symbol] l₁ [symbol] l₂, V is the contrast of the beat frequency signal, and V=\sqrt{I₁I₂}/(I₁+I₂), Δv is a modulation width of optical frequency modulation, vₘ is the frequency of a modulation signal, c is the speed of light, t is time, λ₀ is the wavelength of a light wave in vacuum, v_{b} is the frequency of the beat frequency signal, and ϕ_{b0} is the initial phase of the beat frequency signal. OPD is the optical path difference between the reference light and the signal light, obviously

$${v}_{b} = \frac{2 π Δ {vv}_{m} OPD}{c}$$

$${φ}_{b 0} = \frac{2 π}{{λ}_{0}} OPD$$

For the frequency modulation continuous wave laser interference displacement sensor, the optical path difference OPD=2nd. Obviously, the initial phase of the beat frequency signal can be written as:

$${φ}_{b 0} = \frac{4 π nd}{{λ}_{0}}$$

n is the air refractive index (n≈1), and d is the distance between the reflecting surface of the partial reflecting mirror 4 and the reflecting surface of the cooperative reflecting mirror 5 attached to the surface of the target moving object. When the target moving object drives the [symbol] operative reflecting mirror 5 to move by a distance δd, the offset of the initial phase ϕ_{b0} is

$$δ {φ}_{b 0} = \frac{4 π n δ d}{{λ}_{0}}$$

$$and$$

$$δ d = \frac{{λ}_{0}}{4 π n} δ {φ}_{b 0}$$

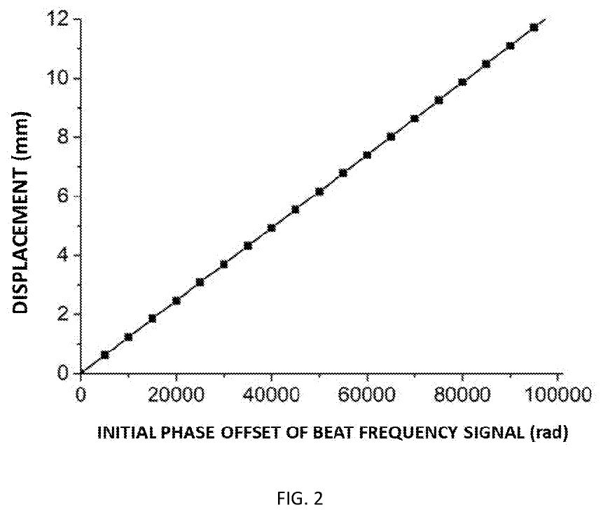

The beat frequency signal is transmitted into the original emergent port of the optical circulator 2, outputted from the third port of the optical circulator 2, coupled to the photoelectric detector 6 via the optical fiber, and converted into the electrical signal. By measuring the offset δϕ_{b0} of the initial phase, the relative displacement δd of the target moving object can be calculated, as shown in FIG. 2.

It should be noted that, in the present embodiment, the optical circulator 2 uses a 3-port circulator, and in other embodiments, the optical circulator 2 may use a 4-port circulator. The optical fiber collimator 3 may use one of an existing Grin-lens (G-lens) optical fiber collimator, a spherical lens (C-lens) optical fiber collimator or an aspherical optical fiber collimator. The cooperative reflecting mirror [5] providing the signal light may be a partial reflecting mirror, a total reflecting mirror, a dielectric reflecting mirror, or a metal reflecting mirror. The cooperative reflecting mirror needs to be attached to the surface of the measured moving object and moves along with it. Both the partial reflecting mirror 4 and the cooperative reflecting mirror 5 need to be strictly perpendicular to the direction of the laser emitted from the optical fiber collimator 3 to ensure that the reflected reference light and signal light can be coupled back into the original optical fiber path at maximum power by means of the optical fiber collimator 3.

### Embodiment 2

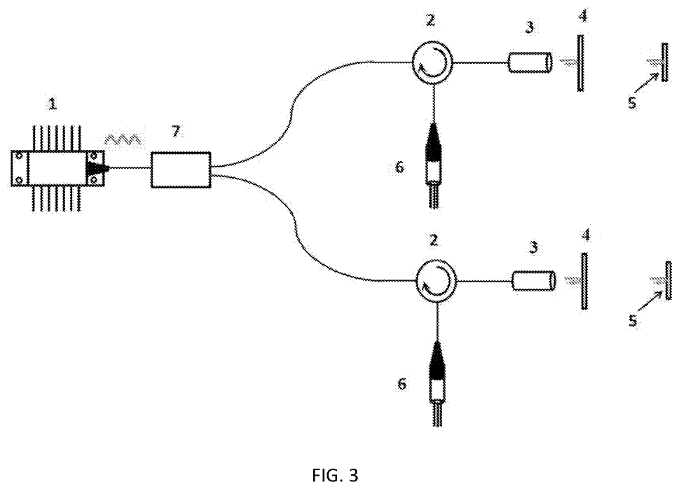

Different from embodiment 1, in the present embodiment, a two-path form frequency modulation continuous wave laser interference optical fiber displacement sensor is provided. Referring to FIG. 3, a single-mode frequency modulation continuous wave laser 1 is connected with two optical fiber displacement sensing systems, specifically, the single-mode frequency modulation continuous wave laser 1 is connected to the two optical fiber displacement sensing systems respectively through a 1×2 optical fiber coupler 7. The arrangement mode and working principle of each of the two optical fiber displacement sensing systems are the same as those of the single-path optical fiber displacement sensing system.

The laser power outputted by the single-mode frequency modulation continuous wave laser 1 is averagely distributed, by the 1×2 optical fiber coupler 7, to the two-path frequency modulation continuous wave laser interference optical fiber displacement sensor for use. The two optical fiber displacement sensing systems respectively and independently measure the displacement of the target object, so that the displacement measurement of two independently moving objects can be realized at the same time, and the measurement of motion displacement amounts of the same object in two-dimensional space can also be realized.

On the basis of the above-mentioned two forms, those skilled in the art may further expand the number of displacement sensing systems, for example, arrange a three-path and multi-path displacement sensing systems. The expansion mode of the three-path and multi-path displacement sensing systems is similar to the expansion mode of the two-path optical fiber displacement sensing system, except that the 1×2 optical fiber coupler 7 is replaced by a 1×3 or 1×N optical fiber coupler 7, and each path is the same as the single-path frequency-modulated continuous wave laser optical fiber displacement sensor.

The present disclosure has been illustrated by applying specific examples above, which is only used to help understand the present disclosure, but not limit the present disclosure. For those skilled in the technical field of the present disclosure, according to the idea of the present disclosure, a number of simple deductions, deformations or substitutions may also be made.

What is claimed is:

1. A frequency modulation continuous wave laser interference optical fiber displacement sensor, comprising a single-mode frequency modulation continuous wave laser and at least one optical fiber displacement sensing system connected with the single-mode frequency modulation continuous wave laser; the optical fiber displacement sensing system comprises an optical circulator, an optical fiber collimator, a partial reflecting mirror, a cooperative reflecting mirror and a photoelectric detector; the single-mode frequency modulation continuous wave laser is connected with an incident port of the optical circulator by means of a single-mode optical fiber or an optical fiber coupler; an adjacent emergent port of the optical circulator is connected with the optical fiber collimator by means of the single-mode optical fiber; a third port of the optical circulator is connected with the photoelectric detector; the partial reflecting mirror is arranged behind the optical fiber collimator; the cooperative reflecting mirror is arranged behind the partial reflecting mirror; and the cooperative reflecting mirror is attached to the surface of a target object to be detected and moves together with the target object to be detected.

2. The frequency modulation continuous wave laser interference optical fiber displacement sensor according to claim 1, wherein the single-mode frequency modulation continuous wave laser is fused to the incident port of the optical circulator by means of the single-mode optical fiber or the optical fiber coupler, or connected to the incident port of the optical circulator by a flange.

3. The frequency modulation continuous wave laser interference optical fiber displacement sensor according to claim 2, wherein the partial reflecting mirror is attached to an emergent end surface of the optical fiber collimator by means of adhesive bonding or mechanical fixing.

4. The frequency modulation continuous wave laser interference optical fiber displacement sensor according to claim 2, wherein an emergent mirror surface of the optical fiber collimator is coated with a partially reflecting and partially transmitting optical film material to form the partial reflecting mirror.

5. The frequency modulation continuous wave laser interference optical fiber displacement sensor according to claim 3, wherein the optical fiber collimator is selected from a Grin-lens (G-lens) optical fiber collimator, a spherical lens (C-lens) optical fiber collimator and an aspherical optical fiber collimator.

6. The frequency modulation continuous wave laser interference optical fiber displacement sensor according to claim 5, wherein the cooperative reflecting mirror is selected from the partial reflecting mirror and a total reflecting mirror.

7. The frequency modulated continuous wave laser interference optical fiber displacement sensor according to claim 6, wherein a dielectric reflecting mirror or a metal reflecting mirror is selected when the cooperative reflecting mirror is the total reflecting mirror.

8. A displacement detection method for the optical fiber displacement sensor according to claim 1, comprising: coupling frequency modulation continuous waves emitted by the single-mode frequency modulation continuous wave laser to the incident port of the optical circulator by means of the single-mode optical fiber or the optical fiber coupler, outputting the frequency modulation continuous waves by the adjacent emergent port of the optical circulator, then coupling and outputting the frequency modulation continuous waves by the optical fiber collimator, reflecting one part of a emergent light by the partial reflecting mirror, transmitting the other part of the emergent light by the partial reflecting mirror and then irradiating the other part of the emergent light onto a mirror surface of the cooperative reflecting mirror moving along with the target object to be detected; and reflecting the light beam by the cooperative reflecting mirror to allow the light beam to be returned to the partial reflecting mirror and superimposed and interfered with the reflected light of the partial reflecting mirror to form a beat frequency signal, coupling the beat frequency signal back to the single-mode optical fiber by the optical fiber collimator and transmitting the beat frequency signal into the optical circulator, transmitting the beat frequency signal out of the third port of the optical circulator, coupling the beat frequency signal to the photoelectric detector by means of the single-mode optical fiber and converting the beat frequency signal into an electric signal, and analyzing the electric signal to acquire the displacement information of the target object.
